(19) United States
(12) Patent Application Publication
(10) Pub. No.: US 2008/0301715 A1
(43) Pub. Date: Dec. 4, 2008

(54) Information processing apparatus, failure notification circuit, and failure notification method

(75) Inventor: Ikkei Kinouchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/149,680

(22) Filed: May 6, 2008

(30) Foreign Application Priority Data
May 31, 2007 (JP) 2007-145114

(51) Int. Cl. G06F 3/00

(52) U.S. Cl. 719/318

(57) ABSTRACT

An information processing apparatus includes a failure-definition information storage unit for pre-storing failure-definition information including failure information regarding failures in the information processing apparatus and identification information regarding whether or not the failures can be fixed by a user who uses the information processing apparatus. The failure information and the identification information are associated with each other. The apparatus further includes: an occurred-failure information generating unit for generating information regarding an occurred failure as occurred-failure information; a determining unit for determining whether or not the occurred failure can be fixed by the user, based on the failure-definition information and the occurred-failure information generated; and a notification unit for issuing a notification to the user, when the determining unit determines that the occurred failure can be fixed by the user.

### BACKGROUND OF THE INVENTION

1. Field of the Invention

The present invention relates to a technology for issuing a notification of a failure in an information processing apparatus, such as a failure in a component included in a server.

2. Description of the Related Art

Typically, when a failure occurs in a computer such as a server, a customer engineer (CE) who received professional training for repairing computers is sent from a support center (hereinafter referred to as a “vendor”) of a manufacture or the like and performs maintenance work, such as replacing a failed component or repairing a failed section, based on the professional knowledge. An example of known technology is disclosed in Japanese Unexamined Patent Application Publication No. 2004-206166.

In recent years, however, with respect to failures that can be fixed without the professional knowledge, for example, corporations (hereinafter referred to as “users”) that use computers increasingly desire a reduction in the amount of time required for maintenance work, a reduction in the maintenance cost, and so on by fixing the failures by themselves.

A known processing scheme when a failure occurs will now be described with reference to the flowchart shown in FIG. 1.

When a failure occurs in a computer (in step S11), a notification of the occurrence of a failure is issued to a user (in step S12).

Upon receiving the notification, the user contacts the vendor to report the occurrence of the failure (in step S13) and also informs about the state of the failure by using communication means, such as a telephone, while referring to, for example, an error log that is recorded in the computer and/or the ON/OFF state of an LED (light emitting diode) that is provided in the computer and that indicates a failed component during occurrence of a failure.

By querying the user for the state of the failure (in step S14), the vender identifies a failed component or a failed section and also determines whether or not the failure can be fixed by the user (in step S15).

When the vender determines that the failure cannot be fixed by the user (see the flow “NO” in step S15), a customer engineer is sent from the vendor to fix the failure (in step S16), and the process then ends.

On the other hand, when the vender determines that the failure can be fixed by the user (see the flow “YES” in step S15), the vendor sends a replacement component corresponding to the failed component (in step S17). The user replaces the failed component with the replacement component (in step S18).

The user then determines whether or not the failure is fixed (in step S19). When the failure is not fixed after the component replacement (see the flow “NO” in step S19), the process returns to step S14.

On the other hand, when the failure is fixed (see the flow “YES” in step S19), the process ends.

Thus, in the known processing scheme when a failure occurs, the vender determines whether or not a failure can be fixed by a user.

However, with the above-described processing scheme, it is significantly difficult for the user to exactly recognize the state of a failure based on an error log and/or an LED or the like indicating a failed section. Thus, when the state of the failure which is reported from the user to the vender is erroneous, the vendor has to query the user again for the state of the failure and/or has to send a customer engineer. Thus, the known processing scheme causes a problem in that the maintenance cost and the amount of time required for the maintenance work cannot be reduced.

Moreover, since the vendor determines whether or not a failure can be fixed by the user, a large amount of time is required for inspection and so on for making the determination. This also causes a problem in that the amount of time required for the maintenance work cannot be reduced.

### SUMMARY

An object of the present invention is to reduce the amount of time required for maintenance work when a failure occurs in an information processing apparatus and to reduce the maintenance cost of the information processing apparatus.

According to an aspect of an embodiment, the information processing apparatus includes a storage unit and a processor. The storage unit pre-stores failure-definition information including failure information regarding failures in the information processing apparatus and identification information regarding whether or not the failures can be fixed by a user who uses the information processing apparatus, the failure information and the identification information being associated with each other. The processor to control the information processing apparatus according to a process includes generating information regarding an occurred failure as occurred-failure information, the occurred failure being a failure that occurred in the information processing apparatus, determining whether or not the occurred-failure is to be fixed by the user based on the failure-definition information stored by the storage unit and the occurred-failure information generated, and issuing a notification to the user upon the determining unit determining the occurred failure being to be fixed by the user.

### BRIEF DESCRIPTION OF THE DRAWINGS

FIG. 1 is a flowchart illustrating a known processing scheme when a failure occurs;

FIG. 2 is a block diagram schematically showing an example of the configuration of a server according to one embodiment of the present invention;

FIG. 3 is a block diagram schematically showing an example of the configuration of a failure notification unit in the server according to the embodiment of the present invention;

FIG. 4 is a diagram illustrating failure-definition information stored in a failure-definition information storage unit in the server according to the embodiment of the present invention;

FIG. 5 is a diagram illustrating error-log information stored in an error-log information storage unit in the server according to the embodiment of the present invention;

FIG. 6 is a table showing a specific example of failure information and identification information used in the server according to the embodiment of the present invention;

FIG. 7 is a table showing a specific example of the failure information and the identification information used in the server according to the embodiment of the present invention; and

FIG. 8 is a flowchart showing one example of a processing scheme when a failure occurs in the server according to the embodiment of the present invention.

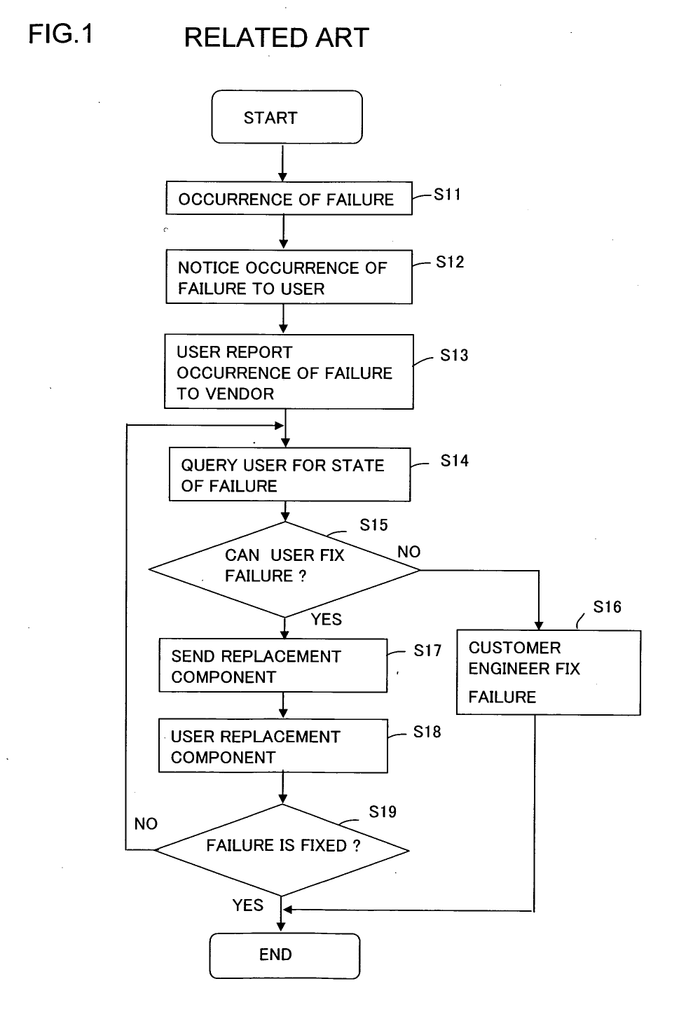

### DESCRIPTION OF THE PREFERRED EMBODIMENT

An embodiment will be described below with reference to the accompanying drawings.

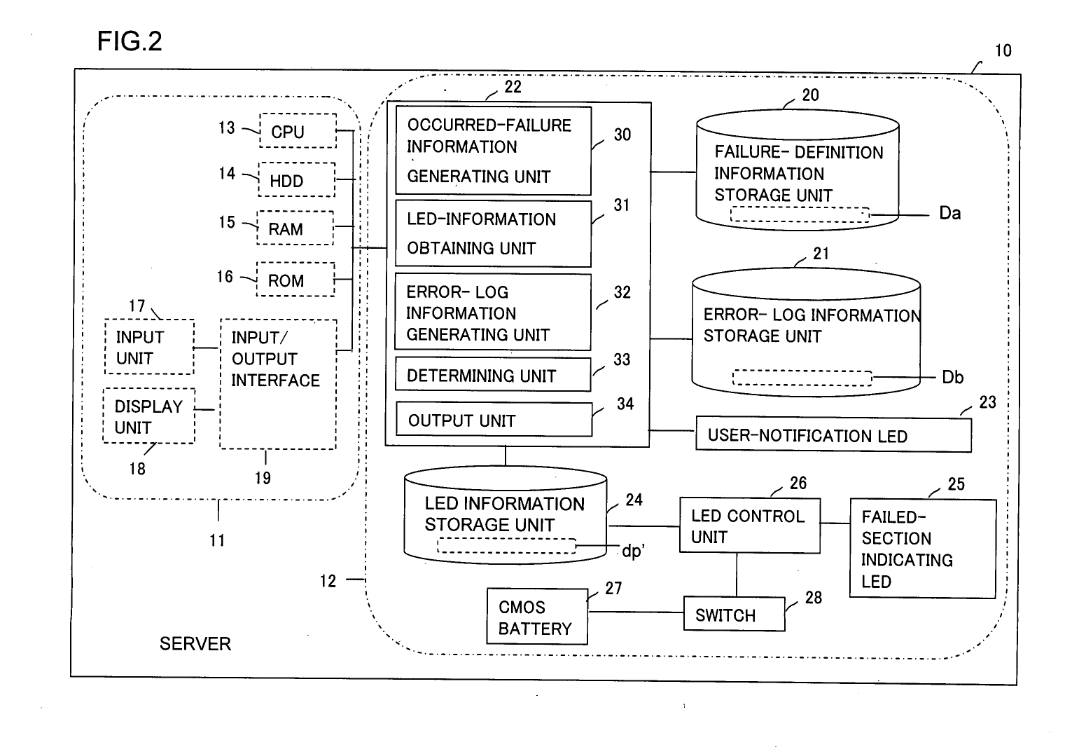

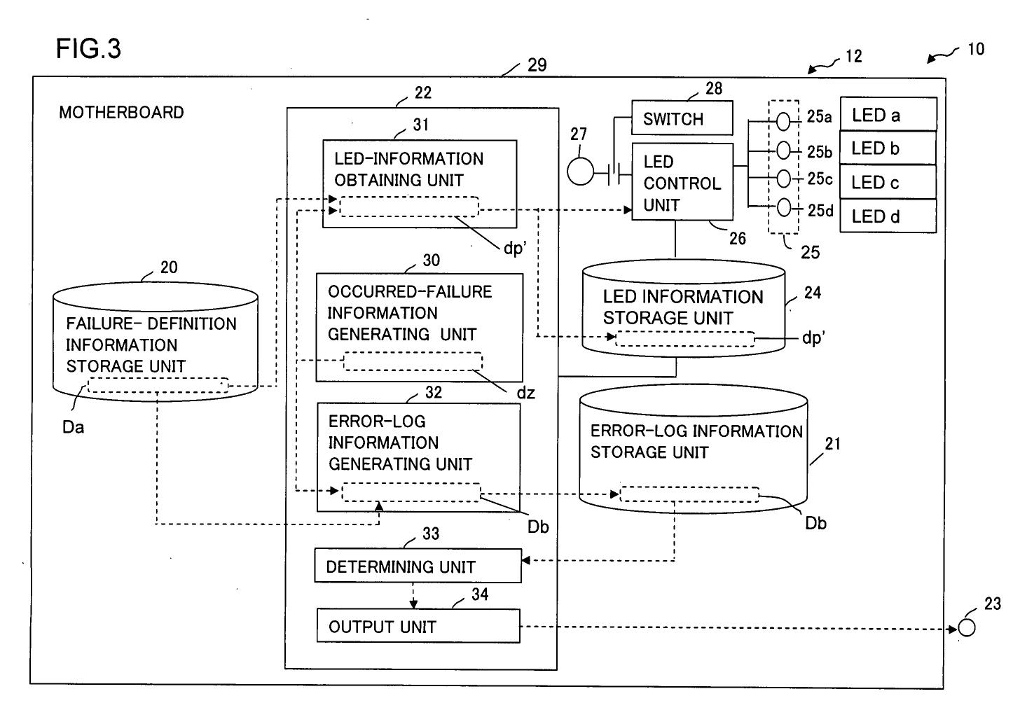

FIG. 2 is a block diagram schematically showing an example of the configuration of a server according to one embodiment, and FIG. 3 is a block diagram schematically showing an example of the configuration of a failure notification unit.

As shown in FIG. 2, a server (an information processing apparatus) 10 according to the present embodiment is configured as a computer having a normal operation unit 11 and a failure notification unit (a failure notification circuit) 12.

The normal operation unit 11 has a function of a typical server. A client terminal (not shown) is connected with the server 10 via a LAN (local area network; not shown) to allow communication. The normal operation unit 11 is adapted to perform various types of processing in accordance with, for example, a request sent from the client.

As shown in FIG. 2, the normal operation unit 11 includes, for example, a CPU (central processing unit) 13, a HDD (hard disk drive) 14, a RAM (random access memory) 15, a ROM (read only memory) 16, an input unit 17, a display unit 18, and an input/output interface 19.

The CPU 13 performs various types of numerical computation, information processing, device control, and so on for the server 10. The HDD 14 serves as a storage device that stores various data and programs including an OS (operating system).

The RAM 15 temporarily loads and stores data and a program to perform various types of computation processing. The ROM 16 stores various data and a program to be executed/processed by the CPU 13.

The input unit 17 includes, for example, a mouse and a keyboard. With the input 17, a user or the like performs various input operations to input data, instructions, and so on to the server 10.

The display unit 18 serves as a display device including, for example, a CRT (cathode ray tube) display or an LCD (liquid crystal display) to display various types of information regarding the server 10. For example, the display unit 18 is adapted to display the contents of a failure that occurs in the server 10.

Input/output devices, such as the input unit 17 and the display unit 18, are connected to the input/output interface 19. The input/output interface 19 is adapted to control various types of input/output processing for the input/output devices.

In addition to the CPU 13, the HDD 14, the RAM 15, the ROM 16, the input unit 17, the display unit 18, and the input/output interface 19, the normal operation unit 11 includes components needed to achieve the function of a typical server (the components may hereinafter be referred to as “sub-components”). Examples of the sub-components include a fan, a chipset, a PCI (peripheral component interconnect) bus, a temperature sensor, and so on. For convenience of illustration, the sub-components are not shown in the drawings, and the descriptions thereof will not be given below.

The failure notification unit 12 serves to issue a notification of a failure (error) in the server 10. As shown in FIG. 2 and FIG. 3, the failure notification unit 12 is configured as a circuit including a failure-definition information storage unit 20, an error-log information storage unit 21, a server management processor 22, a user-notification LED (light emitting diode) 23 serving as a notification unit, an LED information storage unit 24, a failed-section indicating LED 25 serving as a failed-section indicating unit, an LED control unit 26, a CMOS (complementary metal oxide semiconductor) battery 27 serving as a backup battery, and a switch 28.

As shown in FIG. 3, the server 10 includes a motherboard 29. For example, the above-mentioned failure-definition information storage unit 20, the error-log information storage unit 21, the server management processor 22, the LED information storage unit 24, the failed-section indicating LED 25, the LED control unit 26, the CMOS battery 27, and the switch 28 are disposed on the motherboard 29. Further, the CPU 13, the RAM 15, and the ROM 16, as well as some of the sub-components, are provided on the motherboard 29, but are not shown in FIG. 3, for convenience of illustration.

The failed-section indicating LED 25 may be provided at a section other than the motherboard 29 in the server 10, and details of such a configuration will be described below.

In the following description, for convenience of description, components a to d (see FIG. 3) may be used instead of the CPU 13, the HDD 14, the RAM 15, the ROM 16, the input unit 17, the display unit 18, the input/output interface 19, and the sub-components, and in this case, the components a to d refer to any of the CPU 13, the HDD 14, the RAM 15, the ROM 16, the input unit 17, the display unit 18, the input/output interface 19, and the sub-components.

In the following description, the reference characters a to d for the components are used when the individual components need to be specified; however, a term “component” is simply used without the use of the reference characters a to d, when an arbitrary component is specified.

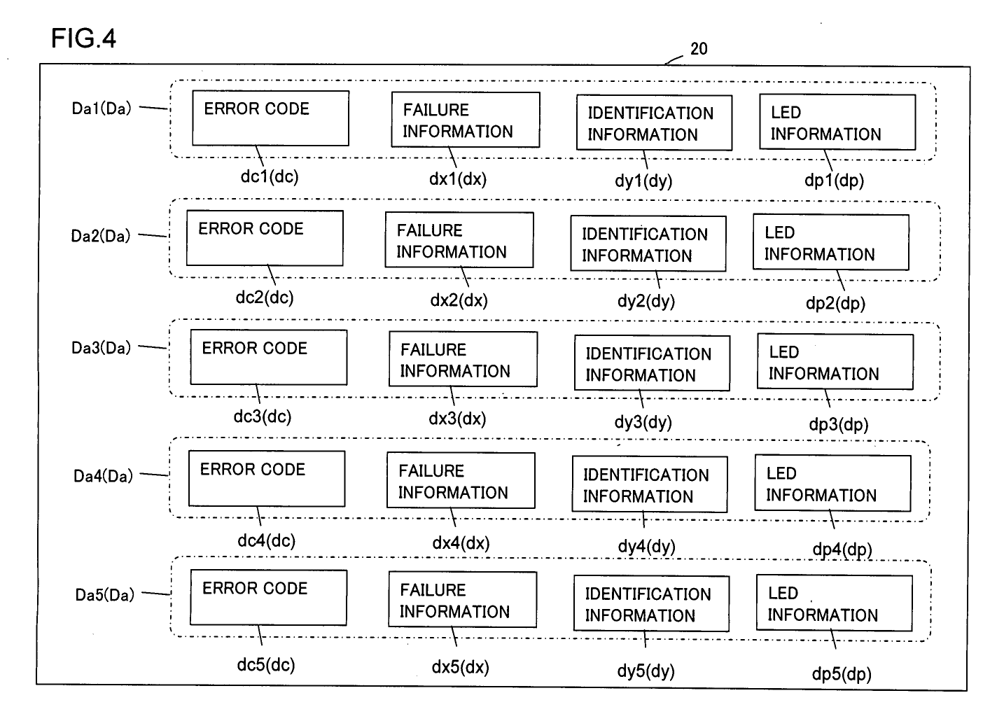

FIG. 4 is a diagram illustrating failure-definition information stored in the failure-definition information storage unit 20 in the server 10 according to the present embodiment.

The failure-definition information storage unit 20 pre-stores failure-definition information Da and is implemented with, for example, a NVRAM (Non Volatile RAM).

In the example shown in FIG. 4, the failure-definition information storage unit 20 stores five pieces of failure-definition information Da, namely, failure-definition information Da1 to Da5.

In the following description, the reference numerals Da1 to Da5 indicating the failure-definition information are used when the individual pieces of failure-definition information need to be specified, but the reference numeral Da is used when an arbitrary piece or pieces of the failure-definition information are specified.

The failure-definition information Da includes failure information dx and identification information dy associated with each other. For example, an operator of a manufacture pre-stores the failure-definition information Da in the failure-definition information storage unit 20 before the shipment of the server 10.

The failure-definition information Da includes, for example, an error code dc and LED information dp, in addition to the failure information dx and the identification information dy. In the example shown in FIG. 4, the failure-definition information Da1 includes an error code dc1, failure information dx1, identification information dy1, and LED information dp1. Similarly, the failure-definition information Da2 includes an error code dc2, failure information dx2, identification information dy2, and LED information dp2, and the failure-definition information Da3 includes an error code dc3, failure information dx3, identification information dy3, and LED information dp3. The failure-definition information Da4 includes an error code dc4, failure information dx4, identification information dy4, and LED information dp4, and the failure-definition information Da5 includes an error code dc5, failure information dx5, identification information dy5, and LED information dp5. That is, the failure-definition information storage unit 20 pre-stores the multiple pieces of failure information dx1 to dx5 and the multiple pieces of identification information dy1 to dy5.

As shown in FIG. 4, in the failure-definition information Da1, the error code dc1, the failure information dx1, the identification information dy1, and the LED information dp1 are associated with each other. Similarly, in the failure-definition information Da2, the error code dc2, the failure information dx2, the identification information dy2, and the LED information dp2 are associated with each other. In the failure-definition information Da3, the error code dc3, the failure information dx3, the identification information dy3, and the LED information dp3 are associated with each other. In the failure-definition information Da4, the error code dc4, the failure information dx4, the identification information dy4, and the LED information dp4 are associated with each other. In the failure-definition information Da5, the error code dc5, the failure information dx5, the identification information dy5, and the LED information dp5 are associated with each other. That is, the failure-definition information storage unit 20 pre-stores the multiple pieces of identification information dy1 to dy5 that are respectively associated with the multiple pieces of failure information dx1 to dx5.

In the following description, the reference numerals dc1 to dc5 indicating the error codes are used when the individual pieces of error codes need to be specified, but the reference numeral dc is used when an arbitrary one or ones of the error codes are specified.

In the following description, the reference numerals dy1 to dy5 indicating the identification information are used when the individual pieces of identification information need to be specified, but the reference numeral dy is used when an arbitrary piece or pieces of the identification information are specified.

In the following description, the reference numerals dp1 to dp5 indicating the LED information are used when the individual pieces of LED information need to be specified, but the reference numeral dp is used when an arbitrary piece or pieces of the LED information are specified.

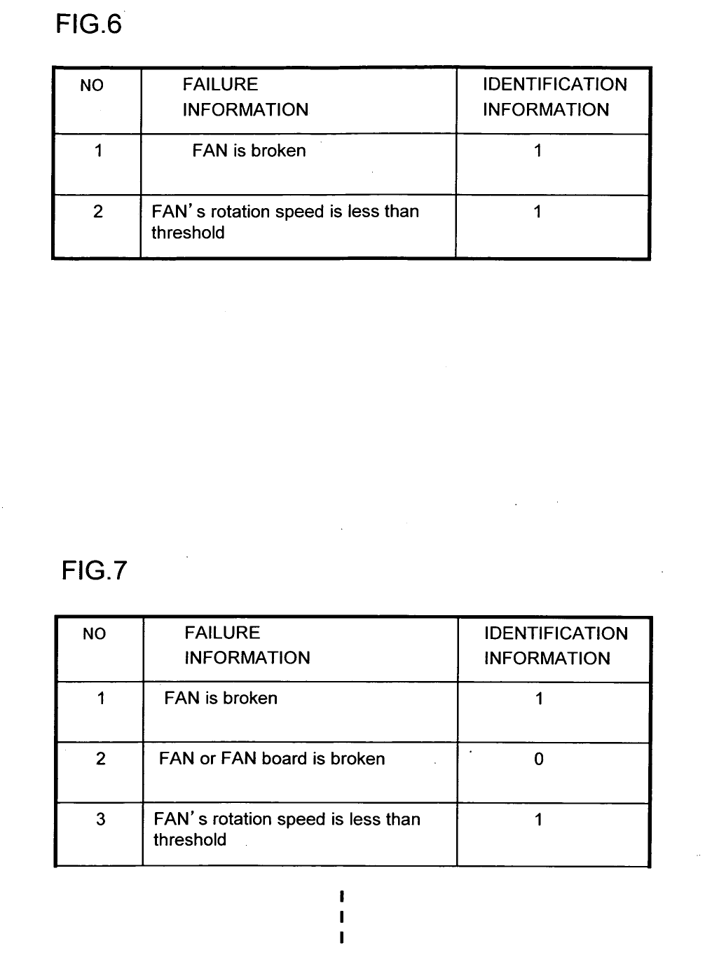

The error code dc is information for specifying a failure in the server 10. The error codes dc are each expressed by, for example, a combination of a numeral and/or a character to specify a malfunction or deterioration in the CPU 13, the HDD 14, the RAM 15, the ROM 16, the input unit 17, the display unit 18, the input/output interface 19, and the sub-components included in the server 10. The failure information dx is information regarding a failure in the server 10 and shows specific contents of a failure specified by the error code dc. For example, with respect to a malfunction in the CPU 13, the HDD 14, the RAM 15, the ROM 16, the input unit 17, the display unit 18, the input/output interface 19, or the sub-component included in the server 10, the failure information dx specifically shows the position and a cause of the malfunction and/or the state of a deterioration (e.g., see “Failure Information” shown in FIG. 6 and FIG. 7).

The identification information dy shows whether or not a failure corresponding to the failure information dx associated with the identification information dy can be fixed by a person who is regarded as not having professional knowledge about repairing the server 10 (such a person will hereinafter be referred to as a “typical user”). In the present embodiment, the identification information is expressed by bits. For example, when a failure corresponding to the associated failure information dx can be fixed by the typical user, “1” is defined as the identification information dy, and when a failure corresponding to the associated failure information dx cannot be fixed by the typical user, “0” is defined as the identification information dy (e.g., see “Identification Information” shown in FIG. 6 and FIG. 7).

Based on determination criteria of the manufacturer or the like, whether or not a failure can be fixed by the typical user is pre-determined in accordance with the contents of the failure in the server 10, how to deal with, and so on.

The LED information dp specifies the position of failed-section indicating LED 25, which is described below. The LED information dp is expressed by code having a combination of a numeral and/or a character to specify the position of the failed-section indicating LED 25, which is disposed adjacent to the CPU 13, the HDD 14, the RAM 15, the ROM 16, the input unit 17, the display unit 18, the input/output interface 19, and the sub-components included in the server 10. The LED information dp may include the name of a failed component or information (such as a component number or address) for identifying the component.

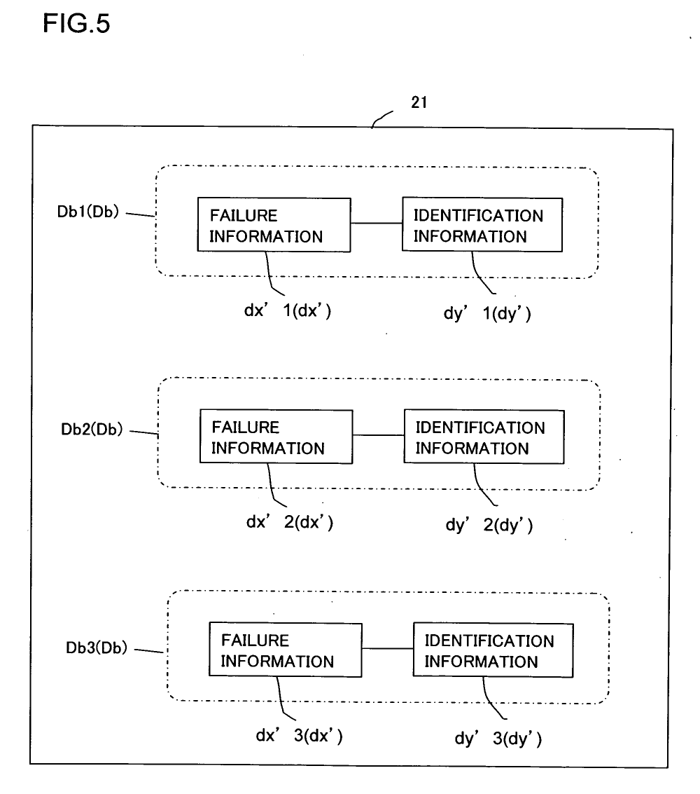

FIG. 5 is a diagram illustrating error-log information stored in the error-log information storage unit 21 in the server 10 according to the present embodiment.

The error-log information storage unit 21 stores error-log information Db (see FIG. 5) generated by an error-log information generating unit 32, which is described below. The error-log information storage unit 21 is implemented with an NVRAM, similarly to the above-described failure-definition information storage unit 20. Details of the error-log information Db will be described below.

The server management processor 22 performs information processing, device control, and so on for, for example, monitoring and issuing a notification of a failure that occurs in the server 10. As shown in FIG. 2 and FIG. 3, the server management processor 22 includes an occurred-failure information generating unit 30, an LED-information obtaining unit 31, the error-log information generating unit 32, a determining unit 33, and an output unit 34.

The occurred-failure information generating unit 30 generates, as occurred-failure information dz, information regarding an occurred failure, which is a failure that occurred in the server 10. More specifically, the occurred-failure information generating unit 30 periodically monitors an occurred failure, and every time when a failure occurs in the server 10, the occurred-failure information generating unit 30 generates occurred-failure information dz corresponding to the occurred failure. That is, the occurred-failure information generating unit 30 is configured to be capable of generating multiple pieces of occurred-failure information dz. Various known methods can be used to detect an occurred failure.

The occurred-failure information dz includes, for example, an error code corresponding to an occurred failure, a section where the failure occurred, date and time of the occurrence, a component name, a cause, the contents of the failure, and so on. The error code is a code corresponding to the above-described error code dc and is adapted to identify the same failure in the server 10 as a failure identified by the corresponding error code dc. It is desired that the error code be the same as the error code. A section where a failure occurred, date and time of the occurrence, a component name, a cause, and the contents of the failure are not shown in the drawings for convenience of illustration, and descriptions of the information will not be given below.

As shown in FIG. 3, based on the occurred-failure information dz generated by the occurred-failure information generating unit 30, the LED-information obtaining unit 31 obtains (extracts) LED information dp corresponding to the occurred information, as LED information dp′, from the failure-definition information Da stored in the failure-definition information storage unit 20.

For example, as shown in FIG. 3, the LED-information obtaining unit 31 stores the obtained LED information dp′ in the LED information storage unit 24, which is described below, and also outputs the LED information dp′ to the LED control unit 26, which is described below.

As shown in FIG. 3, the error-log information generating unit 32 generates failure-definition information Da corresponding to the occurred-failure information dz as error-log information Db, based on the failure-definition information Da stored in the failure-definition information storage unit 20 and the occurred-failure information dz generated by the occurred-failure information generating unit 30.

More specifically, the error-log information generating unit 32 selects, from the failure-definition information Da stored in the failure-definition information storage unit 20, error code dc that matches error code included in the occurred-failure information dz generated by the occurred-failure information generating unit 30. The error-log information generating unit 32 then extracts the failure information dx and the identification dy associated with the selected error code dc, as failure information dx′ and identification information dy′, from the failure-definition information Da stored in the failure-definition information storage unit 20, to thereby generate the error-log information Db (see FIG. 5). That is, the error-log information Db includes the failure information dx′ and the identification information dy′ corresponding to the respective failure information dx and the identification information dy.

The failure information dx′ and the identification information dy′ are the same as the above-described failure information dx and the identification information dy, and thus, the descriptions thereof will not be given below.

The error-log information Db may include, for example, a section where a failure occurred, the date and time of the occurrence, a component name, a cause, and the contents of the failure which are included in the occurred-failure information dz generated by the occurred-failure information generating unit 30, in addition to the above-described failure information dx′ and the identification information dy′.

As shown in FIG. 3, the error-log information generating unit 32 stores the generated error-log information Db in the error-log information storage unit 21.

In the example shown in FIG. 5, error-log information Db1 includes failure information dx′1 and identification information dy′1 which are associated with each other, error-log information Db2 includes failure information dx′2 and identification information dy′2 which are associated with each other, and error-log information Db3 includes failure information dx′3 and identification information dy′3 which are associated with each other.

The determining unit 33 determines whether or not a occurred failure or occurred failures can be fixed by the typical user, based on the error-log information Db stored in the error-log information storage unit 21 (see FIG. 3). For example, all occurred failures corresponding to multiple pieces of error-log information Db1 to Db3 stored in the error-log information storage unit 21 can be fixed by the typical user, the determining unit 33 is adapted to determine that the failures can be fixed by the typical user. That is, the determining unit 33 determines whether or not an occurred failure or occurred failures can be fixed by the typical user, based on the failure-definition information Da stored in the failure-definition information storage unit 20 and the occurred-failure information dz generated by the occurred-failure information generating unit 30.

FIGS. 6 and 7 are tables showing specific examples of the failure information dx and the identification information dy used in the server 10 according to the embodiment of the present invention. FIG. 6 is a table illustrating an example of a case in which it is determined that failures can be fixed by the typical user, and FIG. 7 is a table illustrating an example of a case in which it is determined that failures cannot be fixed by the typical user.

Specifically, in the example shown in FIG. 6, failures occurred in the server 10 are “Fan is broken” and “Fan's rotation speed is less than threshold”. Since the failures can be fixed by the typical user (i.e., the identification information dy′ of the failures indicates “1”), the determining unit 33 determines that the failures can be fixed by the typical user.

For example, in the example shown in FIG. 7, failures occurred in the server 10 are “Fan is broken”, “Fan or fan board is broken”, and “Fan's rotation speed is less than threshold”. Since at least the failure “Fan or fan board is broken” is a failure that cannot be fixed by the typical user (i.e., since the identification information dy′ of the failure indicates “0”), the determining unit 33 determines that the failure cannot be fixed by the typical user.

When the determining unit 33 determines that a failure can be fixed by the typical user, the output unit 34 outputs a notification indicating so. In the present embodiment, the output unit 34 outputs the notification by turning on the user-notification LED 23, which is described below.

For example, when the determining unit 33 determines that a failure can be fixed by the typical user, the user-notification LED 23 is turned on to issue a notification indicating so to the typical user. For example, as shown in FIG. 3, the output unit 34 outputs a signal indicating that the determining unit 33 determined that a failure can be fixed by the typical user, to thereby turn on the user-notification LED 23. A specific circuit configuration and so on for turning on the user-notification LED 23 is realized by a known method, and a detailed description thereof will not be given for convenience of description.

The user-notification LED 23 is disposed on, for example, a housing of the server 10 so as to allow user viewing.

The LED information storage unit 24 stores the LED information dp′ obtained by the LED-information obtaining unit 31 (see FIG. 3). The LED information storage unit 24 is implemented with, for example, an NVRAM, similarly to the failure-definition information storage unit 20 and the error-log information storage unit 21.

The failed-section indicating LED 25 indicates a failed section in the server 10. In the present embodiment, the failed-section indicating LED 25 is turned on adjacent to a failed component (or a failed section). That is, the failed-section indicating LED 25 is disposed adjacent to a failed section.

In the example shown in FIG. 3, multiple failed-section indicating LEDs 25a to 25d are disposed, on the motherboard 29, adjacent to the components a to d, respectively. More specifically, the failed-section indicating LED 25a is disposed in the vicinity of the component a, the failed—section indicating LED 25b is disposed in the vicinity of the component b, the failed-section indicating LED 25c is disposed in the vicinity of the component c, and the failed-section indicating LED 25d is disposed in the vicinity of the component d.

With respect to components that are not disposed on the motherboard 29, the failed-section indicating LEDs 25 are disposed on areas other than the motherboard 29.

In the following description, the reference characters 25a to 25d that represent the failed-section indicating LEDs are used when the individual failed-section indicating LEDs 25 need to be specified; however, a reference character 25 is used when an arbitrary one or ones of the failed-section indicating LEDs 25 are specified.

The LED control unit 26 performs control so as to turn on the failed-section indicating LED 25 adjacent to a failed component, based on the LED information dp1 obtained by the LED-information obtaining unit 31. For example, the LED control unit 26 supplies power to the failed-section indicating LED 25 that is specified by the LED information dp′ obtained by the LED-information obtaining unit 31 so as to be turned on, to thereby turn on the failed-section indicating LED 25 to which the power is supplied.

In the example shown in FIG. 3, the LED control unit 26 turns on the failed-section indicating LED 25a, when a failure occurs in the component a. Similarly, the LED control unit 26 turns on the failed-section indicating LEDs 25b and 25c, when failures occur in the components b and c, and turns on the failed-section indicating LEDs 25a to 25d, when failures occur to the components a to d.

The CMOS battery 27 is a compact battery for supplying backup power to a CMOS memory on the motherboard and for supplying power to a clock circuit. In the present embodiment, the CMOS battery 27 is disposed on the motherboard 29 and is capable of supplying power to the failed-section indicating LEDs 25a to 25d via the switch 28, which is described below.

The switch 28 is, for example, a push-button switch to turn on/off power supplied from the CMOS battery 27 to the failed-section indicating LEDs 25. For example, when power supply external to the motherboard 29 is shut off (e.g., when power supply to the server 10 is shut off) and the switch 28 is pressed, the server 10 is adapted to be put into a state in which power can be supplied from the CMOS battery 27 to the failed-section indicating LEDs 25. The switch 28 is provided on the mother board 29.

In the state in which the switch 28 permits power to be supplied to the failed-section indicating LEDs 25, the LED control unit 26 performs control to turn on an arbitrary one or ones of the failed-section indicating LEDs 25.

Thus, upon supply of power from the CMOS battery 27 disposed on the motherboard 29 in the server 10, the failed-section indicating LEDs 25 are turned on.

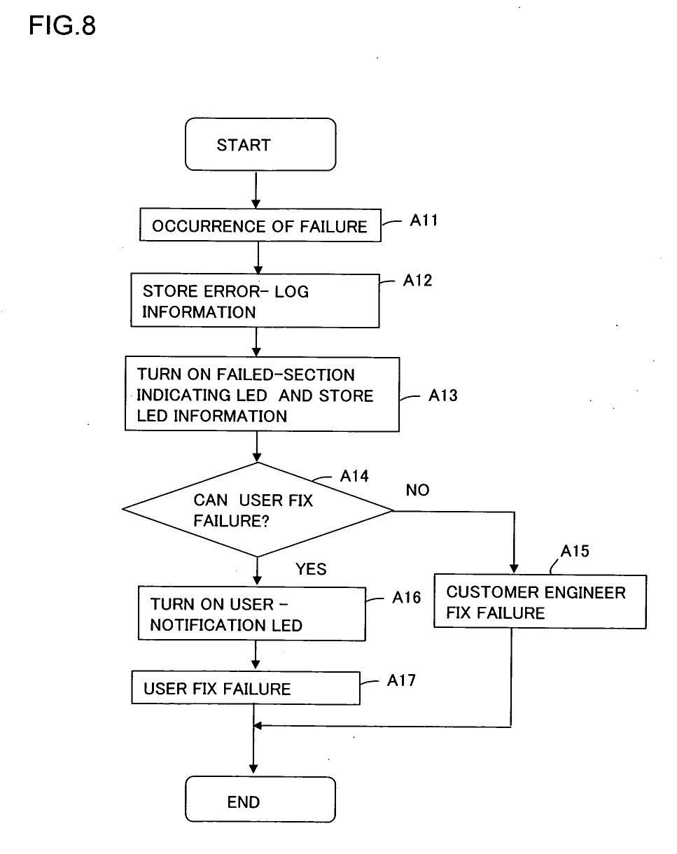

One example of a processing scheme when a failure occurs in the server 10 configured as described above according to the embodiment of the present invention will now be described with reference to the flowchart (steps A11 to A17) shown in FIG. 8.

It is assumed that the failure-definition information storage unit 20 pre-stores the failure-definition information Da and the server management processor 22 periodically monitors the presence/absence of a failure.

When a failure occurs in the server 10 (in step A11), the occurred-failure information generating unit 30 generates occurred-failure information dz (this step is referred to as an “occurred-failure information generating step”).

Based on the failure-definition information Da stored in the failure-definition information storage unit 20 and the occurred-failure information dz generated by the occurred-failure information generating unit 30, the error-log information generating unit 32 generates, as error-log information Db, failure-definition information Da corresponding to the occurred-failure information dz (this step is referred to as an “error-log information generating step) and stores the generated error-log information Db in the error-log information storage unit 21 (in step A12). Based on the occurred-failure information dz generated by the occurred-failure information generating unit 30, the LED-information obtaining unit 31 obtains LED information dp corresponding to the occurred failure, as LED information dp′, from the failure-definition information Da stored in the failure-definition information storage unit 20.

The LED control unit 26 turns on the failed-section indicating LED 25 that is specified by the LED information dp′ obtained by the LED-information obtaining unit 31 so as to be turned on and the LED information storage unit 24 stores the LED information dp′ obtained by the LED information obtaining unit 31 (in step A13).

Based on the error-log information Db stored in the error-log information storage unit 21, the determining unit 33 determines whether or not the occurred failure can be fixed by the typical user (in step A14; a determining step)

When it is determined that the occurred failure cannot be fixed by the typical user (see the flow “NO” in step A14), the output unit 34 does not perform output to the user-notification LED 23 to maintain the OFF-state of the user-notification LED 23.

The typical user then checks the OFF-state of the user-notification LED 23 and requests a support center or the like (hereinafter referred to as a “vendor”) to fix the failure. In response to the request, the vendor sends a customer engineer (CE) who received professional training for fixing the server 10 and the customer engineer fixes the failure in the server 10 (in step A15). The process then ends.

On the other hand, when it is determined that the failure can be fixed by the typical user (see the flow “YES” in step A14), the output unit 34 performs output to the user-notification LED 23 to turn on the user-notification LED 23 (in step A16: a notifying step). The typical user then checks the ON-state of the user-notification LED 23 and fixes the failure by replacing a failed component with a normal component or repairing a failed section (in step A17). The process then ends.

Thus, in the present embodiment, the failure notification unit 12 included in the server 10 determines whether or not a failure can be fixed by the typical user.

As described above, the server 10 according to the embodiment of the present invention generates the error-log information Db, based on the failure-definition information Da including the failure information dx and the identification information dy associated with each other and the occurred-failure information dz. When it is determined based on the generated error-log information Db that the failure can be fixed by the typical user, the server 10 issues a notification to the typical user. With this arrangement, when a failure occurs in the server 10, the typical user can immediately know whether or not the failure can be fixed by himself/herself. When it is determined that the failure can be fixed by the typical user himself/herself, he or she can fix the failure without relying on a costly maintenance service provided by a customer engineer. Thus, when a failure occurs in the server 10, it is possible to reduce the amount of time required for the maintenance work and it is also possible to reduce the maintenance cost of the server 10.

In addition, since the determining unit 33 determines whether or not a failure can be fixed by a typical user based on the error-log information Db, it is possible to reduce the amount of misdiagnosis on a failure occurred in the server 10.

Additionally, the occurred-failure information generating unit 30 generates multiple pieces of occurred-failure information dz. Thus, when all occurred failures corresponding to the generated occurred-failure information dz can be fixed by a typical user, the determining unit 33 determines that the occurred failures can be fixed by the typical user. Thus, when even one failure that cannot be fixed by the typical user himself/herself occurs, he/she can immediately give a request for sending a customer engineer. Accordingly, it is possible to reduce the amount of time required for the maintenance work when a failure or failures occur in the server 10.

Further, since the failed-section indicating LEDs 25 for each indicating a section where a failure occurs in the server 10 are provided and are turned on during the occurrence of a failure or failures, it is possible to easily identify a failed section during maintenance work and it is also possible to reduce the amount of time from occurrence of a failure until identification of a failed section or a failed component.

Moreover, since the failed-section indicating LEDs 25a to 25d are disposed adjacent to the components a to d, it is possible to reliably and easily identify a failed section or failed sections during maintenance work.

Also, since the failed-section indicating LEDs 25 are turned on with power supplied from the CMOS battery 27 provided on the motherboard 29, it is possible to indicate a failed section or failed sections even when the power supplied from a main power source or the like is shut off and it is also possible to easily identify the failed section(s). In addition, this arrangement can eliminate the need for an expensive component, such as a super-capacitor, for supplying power to the failed-section indicating LEDs 25, and thus can reduce the component cost.

This arrangement is economical without wasting power of the CMOS battery 27, by turning on the failed-section indicating LED(s) 25 via the switch 28 only when necessary.

The present invention is not limited to the above-described embodiment, and various changes and modifications can be made thereto without departing from the spirit and scope of the present invention.

For example, an example in which the normal operation unit 11 includes the CPU 13, the HDD 14, the RAM 15, the ROM 16, the input unit 17, and the display unit 18, and the input/output interface 19 has been described in the above-described embodiment, the present invention is not limited thereto. Thus, various changes and modifications can be made within a scope in which various types of processing for realizing a server function can be performed. For example, the server may include multiple normal operation units 11.

Although an example in which the server 10 has one motherboard 29 has been described in the above-described embodiment, the present invention is not limited thereto and the server 10 may have multiple motherboards 29. In such a case, for example, the motherboards 29 may have the failure notification units 12 to monitor occurred failures, respectively. Alternatively, one of the multiple motherboards 29 may have the failure notification unit 12 and manage the occurrence of a failure or failures on the other motherboards 29 to monitor the failure(s) that occurs in the entire server 10.

When the multiple motherboards 29 have the respective failure notification units 12, multiple user-notification LEDs 23 may be provided so as to correspond to the multiple failure notification units 12 so that the user-notification LED 23 can be turned on for each motherboard 29. Alternatively, instead of the multiple user-notification LEDs 23, one user-notification LED 23 may be provided so as to be turned on for the entire server 10. In this case, it is desired that an AND operation be performed on values from the failure notification units 12 and the user-notification LED 23 be turned on only when all occurred failures can be fixed by the typical user. When components (such as the HDD 14, the input unit 17, and the display unit 18) that can be shared are shared by the multiple motherboards 29, one of the motherboards 29 may monitor a failure.

Although LEDs, such as the user-notification LEDs 23 and the failed-section indicating LEDs 25 are used to issue a notification to the user in the above-described embodiment, the present invention is not limited thereto and various known schemes may be used to issue a notification to the user.

Additionally, although the 20, the error-log information storage unit 21, and the LED information storage unit 24 are implemented with an NVRAM in the above-described embodiment, the present invention is not limited thereto and various known storage devices may be used. For example, when a HDD is used, it does not necessarily have to be provided on the motherboard 29.

The server management processor 22 is also adapted to execute a failure notification program to achieve the functions of the occurred-failure information generating unit 30, the LED-information obtaining unit 31, the error-log information generating unit 32, the determining unit 33, and the output unit 34.

The failure notification program for achieving the functions of the occurred-failure information generating unit 30, the LED-information obtaining unit 31, the error-log information generating unit 32, the determining unit 33, and the output unit 34 may be supplied in the form of a computer-readable storage medium, for example, a flexible disk, a CD (such as CD-ROM, CD-R, or CD-RW), a DVD (such as DVD-ROM, DVD-RAM, DVD-R, DVD+R, DVD-RW, or DVD+RW), a magnetic disk, an optical disk, and a magneto-optical disk. The computer then reads the program from the storage medium, transfers the program to an internal or external storage medium, and stores the program therein for use. Alternatively, the program may be recorded to a storage device (a storage medium), such as a magnetic disk, an optical disk, or a magneto-optical disk and be supplied from the storage device to the computer via a communication channel.

A microprocessor in the computer executes the program stored in the internal storage device to achieve the functions of the occurred-failure information generating unit 30, the LED-information obtaining unit 31, the error-log information generating unit 32, the determining unit 33, and the output unit 34. In this case, the computer may read and execute the program stored in the storage medium. The term “computer” in the present embodiment has a concept including hardware and an operating system and refers to hardware that is operated under the control of an operating system. When hardware is operated on an application program without an operating system, the hardware itself corresponds to the computer. The hardware includes at least a microprocessor, such as a CPU, and means for reading a computer program stored on a storage medium. In the present embodiment, the server 10 has the function of the computer.

In addition, various computer-readable medium, for example, an IC card, a ROM cartridge, a magnetic tape, a punch card, an internal storage device (a memory, such as a RAM or ROM) in a computer, an external storage device, and printing material on which code such as a barcode is printed, in addition to the above-mentioned flexible disk, CD, DVD, magnetic disk, optical disk, and magneto-optical disk may be used as the storage device in the present embodiment.

What is claimed is:

1. An information processing apparatus comprising:
a storage unit for pre-storing failure-definition information including failure information regarding failure in the information processing apparatus and identification information regarding whether the failure is to be fixed by a user, the failure information and the identification information being associated with each other;
a processor to control the information processing apparatus according to a process including:
generating occurred-failure information of the failure occurring in the information processing apparatus;
determining whether the occurred-failure is to be fixed by the user, by using the failure-definition information stored by the storage unit and the occurred-failure information generated; and
issuing a notification to the user, upon determining the occurred-failure being to be fixed by the user.

2. The information processing apparatus according to claim 1, wherein, generating process generates multiple pieces of the occurred-failure information, and determining process determines that the occurred-failures are fixed by the user when all of the occurred-failures corresponding to the multiple pieces of the occurred-failure information are fixed by the user.

3. The information processing apparatus according to claim 1, further comprising a failed-section indicating unit for indicating a failed section in the information processing apparatus on the basis of the occurred-failure information generated.

4. The information processing apparatus according to claim 3, wherein the failed-section indicating unit is disposed adjacent to the failed section.

5. The information processing apparatus according to claim 3, wherein the failed-section indicating unit is turned on by power supplied from a backup battery provided on a motherboard included in the information processing apparatus.

6. A failure notification circuit for issuing a notification of a failure in an information processing apparatus, the failure notification circuit comprising:
a storage unit for pre-storing failure-definition information including failure information regarding failure in the information processing apparatus and identification information regarding whether the failure is to be fixed by a user, the failure information and the identification information being associated with each other;
a generating unit for generating occurred-failure information of the failure occurring in the information processing apparatus;
a determining unit for determining whether the occurred-failure is to be fixed by the user, by using the failure-definition information stored by the storage unit and the occurred-failure information generated; and
an output unit for performing output to a notification unit for issuing a notification to the user, upon the determining unit determining the occurred-failure being to be fixed by the user.

7. The failure notification circuit according to claim 6, wherein generating unit generates multiple pieces of the occurred-failure information, and determining unit determines that the occurred-failures are fixed by the user when all of the occurred-failures corresponding to the multiple pieces of the occurred-failure information are fixed by the user.

8. The failure notification circuit according to claim 6, further comprising a failed-section indicating unit for indicating a failed section in the information processing apparatus based on the occurred-failure information generated by the generating unit.

9. The failure notification circuit according to claim 8, wherein the failed-section indicating unit is disposed adjacent to the failed section.

10. The failure notification circuit according to claim 8, wherein the failed-section indicating unit is turned on with power supplied from a backup battery provided on a motherboard included in the information processing apparatus.

11. A failure notification method for issuing a notification of a failure in an information processing apparatus, comprising the step of:
(a) generating occurred-failure information of the failure occurring in the information processing apparatus;
(b) determining whether the occurred-failure is to be fixed by the user, by using the failure-definition information stored by the storage unit and the occurred-failure information generated; and
(c) issuing a notification to the user, upon determining the occurred-failure being to be fixed by the user.

12. The failure notification method according to claim 11, generating multiple pieces of the occurred-failure information in step (a), and determining that the occurred-failures are fixed by the user when all of the occurred-failures corresponding to the multiple pieces of the occurred-failure information are fixed by the user in step (b).

13. The failure notification method according to claim 11, further comprising the step of:
indicating a failed section in the information processing apparatus on basis of the occurred-failure information generated.

14. The failure notification method according to claim 13, wherein, in step (d), the failed section is indicated adjacent to the failed section.
